(19) United States
(12) Patent Application Publication
(10) Pub. No.: US 2011/0207027 A1
(43) Pub. Date: Aug. 25, 2011

(54) HYDROGEN SUPPLY TANK, AND HYDROGEN SUPPLY APPARATUS, HYDROGEN SUPPLY METHOD AND HYDROGEN-CONSUMING DEVICE USING THE SAME

(75) Inventors: Chang Soo KIM, Daegu (KR); Jong Yup HONG, Seoul (KR); Byoung Sung AHN, Seoul (KR); Hyun Joo LEE, Gwangmyeong-si (KR); Suk-Woo NAM, Seoul (KR)

(73) Assignee: KOREA INSTITUTE OF SCIENCE AND TECHNOLOGY, Seoul (KR)

(21) Appl. No.: 13/013,073

(22) Filed: Jan. 25, 2011

(30) Foreign Application Priority Data
Feb. 10, 2010 (KR) 10-2010-0012437

(51) Int. Cl. H01M 8/00; B65D 88/12; B67D 7/00

(52) U.S. Cl. 429/515; 220/564; 222/3; 222/1

(57) ABSTRACT

Disclosed is a hydrogen supply tank including at least one hydrogen-generating container mounted thereto, wherein the hydrogen-generating container receives a hydrogen-generating material capable of heat emission and dehydrogenation under heating, and has a hydrogen discharge path that allows discharge of the generated hydrogen, on the wall surface thereof; the tank has a plurality of divided sections formed therein; the hydrogen-generating container is mounted to each section; and the hydrogen supply tank stores the hydrogen discharged from the hydrogen-generating container and supplies the hydrogen to external sites. Disclosed also are a hydrogen supply apparatus, a hydrogen supply method and a hydrogen-consuming device using the same.

### CROSS-REFERENCE TO RELATED APPLICATION

This application claims priority to Korean Patent Application No. 10-2010-0012437, filed on Feb. 10, 2010, and all the benefits accruing therefrom under 35 U.S.C. §119, the contents of which in its entirety are herein incorporated by reference.

### BACKGROUND

1. Field

The present disclosure relates to a hydrogen supply tank, and a hydrogen supply apparatus, a hydrogen supply method and a hydrogen-consuming device using the same. More particularly, the present disclosure relates to a box-type low-pressure hydrogen supply tank, and a hydrogen supply apparatus, a hydrogen supply method and a hydrogen-consuming device using the same. The hydrogen supply apparatus and hydrogen supply method may be applied to fuel cells and hydrogen combustion systems, which may be useful for vehicles.

2. Description of the Related Art

There is an increasing demand for renewable alternative energy due to fossil energy exhaustion and environmental pollution. Hydrogen has been spotlighted recently as one of such alternative energy sources.

Fuel cells and hydrogen combustion systems use hydrogen as a reactant gas. In order to apply fuel cells and hydrogen combustion systems to vehicles, etc., technology for stable and continuous supply and storage of hydrogen is required.

To supply hydrogen to a hydrogen-consuming device, it is possible to use a method of supplying hydrogen from a separately provided hydrogen supply site whenever necessary.

Alternatively, a hydrogen-generating material is installed in a hydrogen-consuming device, so that hydrogen may be generated from the reaction of the corresponding material and then supplied to the hydrogen-consuming device.

### SUMMARY

The present disclosure is directed to providing a hydrogen supply tank, which generates hydrogen efficiently from a dehydrogenatable material that emits heat spontaneously when heated initially without any separated solid or liquid catalyst, stores hydrogen in a low-pressure low-weight mode and supplies hydrogen to a hydrogen-consuming device, as well as a hydrogen supply apparatus, a hydrogen supply method and a hydrogen-consuming device using the same.

The present disclosure is also directed to providing a hydrogen supply tank including a divided section that enables the hydrogen supply tank to endure a high pressure applied thereto, as well as a hydrogen supply apparatus, a hydrogen supply method and a hydrogen-consuming device using the same.

Further, the present disclosure is directed to providing a hydrogen supply tank capable of minimizing an increase in weight caused by wirings and controller installment, as well as a hydrogen supply apparatus, a hydrogen supply method and a hydrogen-consuming device using the same.

In one aspect, there is provided a hydrogen-generating container, which receives a hydrogen-generating material capable of heat emission and dehydrogenation under heating, and has a hydrogen discharge path that allows discharge of the generated hydrogen, on the wall surface thereof.

In one exemplary embodiment, the container may be a cylindrical casing that includes a through-hole formed on one circular wall surface thereof so as to allow hydrogen discharge and a line-shaped hydrogen discharge path formed on a lateral surface thereof.

In another exemplary embodiment, the hydrogen-generating material is provided as a pellet having an opening.

In still another exemplary embodiment, the hydrogen-generating container may further include a heating unit supplying heat to the hydrogen-generating material.

In still another exemplary embodiment, the heating unit generates heat under the supply of electric power from an electric power source.

In still another exemplary embodiment, the heating unit is detachable from the hydrogen-generating container.

In still another exemplary embodiment, the heating unit is a heating rod that receives electric power from an external electric power source to generate heat, and the heating rod is present along the opening of the pellet-like hydrogen-generating material.

In still another exemplary embodiment, the hydrogen-generating container has a volume of 7 cc-20 cc.

In still another exemplary embodiment, the hydrogen-generating container is formed of any one material selected from engineering plastics, SUS alloy and duralumin.

In still another exemplary embodiment, the hydrogen-generating material is an amine borane-based material.

In yet another exemplary embodiment, the hydrogen-generating material is ammonia borane.

According to the exemplary embodiments, there is provided a hydrogen supply tank including at least one hydrogen-generating container mounted thereto, wherein the hydrogen-generating container receives a hydrogen-generating material capable of heat emission and dehydrogenation under heating, and has a hydrogen discharge path that allows discharge of the generated hydrogen, on the wall surface thereof; the tank includes a plurality of divided sections therein; the hydrogen-generating container is mounted to each section; and the hydrogen supply tank stores the hydrogen discharged from the hydrogen-generating container and supplies the hydrogen to external sites.

In one exemplary embodiment, the divided sections of the tank may be formed by a separator installed in the tank. The separator may serve not only to divide sections but also to improve the pressure resistance of the tank.

In another exemplary embodiment, the divided sections of the tank may be lattice-like divided sections, and at least one divided section may have no hydrogen-generating container in order to discharge hydrogen from the tank to external sites.

In still another exemplary embodiment, the tank may include a plurality of tanks connected to each other in series.

In still another exemplary embodiment, the tank having divided sections may have a box-like shape.

In still another exemplary embodiment, a circuit board may be installed outside of the hydrogen supply tank, and the circuit board may include electric wires arranged thereon, wherein the wires are connected to a heating unit supplying heat to the hydrogen-generating material.

According to the exemplary embodiments, there is provided a hydrogen supply apparatus, which includes the hydrogen supply tank, an electric power source that supplies electric power to the heating unit supplying heat to the hydrogen-generating material in the hydrogen-generating container mounted to the hydrogen supply tank, thereby emitting heat, and a controller that controls supply of electric power from the electric power source.

In one exemplary embodiment, the hydrogen supply tank may include a plurality of tanks connected to each other in series to form a hydrogen supply tank package, and a single controller may be provided per package.

In another exemplary embodiment, the controller may be connected to a circuit board, and the circuit board may include electric wires arranged thereon, wherein the electric wires are connected to a heating unit supplying heat to the hydrogen-generating material.

In still another exemplary embodiment, the hydrogen supply tank may include a plurality of tanks connected to each other in series to form a hydrogen supply tank package; a single controller may be provided per package; and the controller may be connected to the circuit board mounted to the outside of each hydrogen supply tank in the package.

According to the exemplary embodiments, there is provided a hydrogen-consuming device including the hydrogen supply tank or the hydrogen supply apparatus.

According to the exemplary embodiments, there is also provided a hydrogen supply method, including: applying heat to the hydrogen-generating material in the hydrogen-generating container to generate hydrogen; discharging the hydrogen generated from the hydrogen-generating container; and storing the discharged hydrogen, in the tank divided section-wise to mount the hydrogen-generating container and supplying the hydrogen to a hydrogen-consuming device.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1a is a schematic view illustrating a hydrogen-generating container according to an exemplary embodiment;

FIG. 1b is a schematic view illustrating a pellet-shaped hydrogen-generating material according to another exemplary embodiment;

FIG. 1c is a schematic view illustrating a heating rod according to still another exemplary embodiment;

FIG. 2a is a schematic view illustrating the structure of the lower part of a hydrogen supply tank according to an exemplary embodiment;

FIG. 2b is a schematic sectional view illustrating the structure of the lower part of the hydrogen supply tank as shown in FIG. 2a;

FIG. 2c is a schematic view illustrating the structure of the upper part of a hydrogen supply tank according to an exemplary embodiment;

FIG. 2d is a schematic sectional view illustrating the structure of the upper part of the hydrogen supply tank as shown in FIG. 2c;

FIG. 2e is a schematic view illustrating a hydrogen-generating container installed in the lower housing of a hydrogen supply tank according to an exemplary embodiment;

FIG. 2f is a schematic view illustrating a circuit design supplying electric power to the heating rod in each hydrogen-generating container according to an exemplary embodiment;

FIG. 3 is a schematic view illustrating a plurality of hydrogen supply tanks arranged in series while being spaced apart from each other by a predetermined distance according to an exemplary embodiment; and

FIG. 4 is a schematic view illustrating a hydrogen supply apparatus including a hydrogen supply tank according to an exemplary embodiment.

### DETAILED DESCRIPTION OF MAIN ELEMENTS

5: hydrogen-generating material
10: hydrogen-generating container
11: container main body
12: line-shaped hydrogen discharge path
15: through-hole
20: separator
40: heating rod
41: electric wire
120: lower housing of hydrogen supply tank
110: upper housing of hydrogen supply tank
300: hydrogen conveying tube
C: controller
F: filter unit
G: pressure measuring unit
H: hydrogen supply tank
P: electric power source
R: regulator
S: safety valve
T: trap unit

### DETAILED DESCRIPTION

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals denote like elements. The shape, size and regions, and the like, of the drawing may be exaggerated for clarity.

As used herein, the term ‘hydrogen supply apparatus’ includes a hydrogen-generating container or hydrogen supply tank.

As used herein, the term ‘hydrogen consuming device’ includes any types of devices using hydrogen, including an electric power generation system, such as a fuel cell which receives hydrogen and generates electric power, a vehicle driven by power supplied partially or totally from the corresponding electric power generation system, or a hydrogen engine using hydrogen combustion energy.

A hydrogen-generating material capable of heat emission and dehydrogenation under heating may generate hydrogen continuously via self-made heat emission without additional heating, once it is initially heated to generate hydrogen.

For example, once amine borane compounds are heated initially to induce thermal decomposition, they may undergo dehydrogenation continuously by exothermic reaction with no requirement of additional heating.

For reference, a hydrogen generation method using thermal decomposition may be compared with a method using a solid catalyst or liquid catalyst. Methods using a solid catalyst or liquid catalyst are intended to minimize supply of a heat energy source required for hydrogen generation through thermal decomposition as well as to increase hydrogen generation rate. In a method using a solid catalyst, amine borane is supported on a solid catalyst and dissolved into a solvent, or water is used as a solvent so that hydrogen may be generated through the hydrolysis of amine borane. In the case of a method using a liquid catalyst (acid, base, organic acid, ionic liquid), hydrogen may be generated through dehydrogenation of amine borane or co-dehydrogenation with a solvent.

Therefore, there has been a need for developing a system for generation, storage and supply of hydrogen, which generates hydrogen through the thermal decomposition of a hydrogen-generating material, such as amine borane, in the absence of such catalysts or solvents, while minimizing supply of a heat energy source required for the thermal decomposition.

When inducing hydrogen generation through the thermal decomposition of a hydrogen-generating material in the absence of catalysts or solvents, careful considerations are needed in constructing a system for generation, storage and supply of hydrogen.

For example, a container, in which hydrogen generated through the thermal decomposition of a hydrogen-generating material is stored, may be frequently subjected to high pressure (e.g. >20 atm). However, a container for high-pressure applications inevitably results in an increase in weight of the overall system. Moreover, it is obvious that making such a high-pressure container has low weight is technically limited and is hardly realized.

We have focused on a container or apparatus for generation, storage and supply of hydrogen, which has low pressure, low weight, compact size and pressure resistance (resistance against high pressure) in view of actual application and commercialization of hydrogen consuming devices.

In addition to such low pressure, low weight, compact size and pressure resistance of the container, modification of the container for storage and supply of hydrogen into various forms is another important consideration. For example, considering applications to vehicles, it is important for the container to be disposed in an adequate position and to be downsized so that the limited space inside of a vehicle may be utilized with high efficiency, while ensuring a predetermined level of hydrogen generation capacity.

Moreover, when constructing a system for generating, storing and supplying hydrogen by using a material generating hydrogen via exothermic reaction, possibility of a chain reaction caused by the exothermic reaction has to be taken into consideration. When unit containers receiving the corresponding hydrogen-generating material are excessively adjacent to each other, exothermic reaction in one container may trigger off a hydrogen-generating reaction in another container. This makes it difficult to control the hydrogen-generating reaction, to control the operation of a hydrogen consuming device, as well as to construct the overall system with low pressure, low weight and compact size.

The present disclosure is made after intensive study and research based on the above-mentioned considerations.

According to exemplary embodiments of the present disclosure, a hydrogen-generating container that receives a hydrogen-generating material capable of heat emission and dehydrogenation under heating is used as a fundamental unit, which, in turn, is mounted to the internal part of a hydrogen supply tank.

When applying heat (e.g. 90° C. or higher) initially to the hydrogen-generating material through a heating unit, the hydrogen-generating material undergoes an exothermic dehydrogenation reaction and the heat derived therefrom makes it possible to continue the dehydrogenation with no requirement of additional heating other than the initial heating. In this manner, it is possible to generate hydrogen to the highest degree.

According to an exemplary embodiment, after generating hydrogen by heating the hydrogen-generating material capable of heat emission and dehydrogenation under heating, the hydrogen discharged from the hydrogen-generating container is stored in a tank and then supplied to a hydrogen consuming device.

As a result, when a heating resistor generating heat from energy provided by way of an external heating source, such as electric power supplied from an electric power source, is used as a heating unit for the hydrogen-generating material, it is possible to minimize electric power requirement from the external source (for example, a heating resistor connected to a 70 V electric power source generates hydrogen to the highest degree merely by operating the electric power source for about 2 minutes or less). In this manner, it is possible to provide a hydrogen supply apparatus with low pressure, low weight and compact size.

Non-limiting examples of the hydrogen-generating material include amine borane-based compounds, such as ammonia borane (NH₃BH₃). Ammonia borane may be used in the form of a compound having a hydrogen content of 19.6%.

The hydrogen-generating material may be solid in favor of its storage in a hydrogen-generating container. More particularly, a solid hydrogen-generating material may be formed into pellets. The pellet may have an opening, through which the heating unit, such as a heating rod, for supplying heat passes. Herein, the heating unit may be detached from the hydrogen-generating container.

To form the hydrogen-generating material into a desired shape, a mold may be preliminarily fabricated and a solid hydrogen-generating material may be introduced to the mold to perform molding, thereby forming a hydrogen-generating material having the corresponding shape.

In the exemplary embodiments disclosed herein, the hydrogen-generating material may be provided as pellets and a hydrogen-generating container capable of receiving the pellets in a limited space is used. In this manner, it is possible to effectively transfer the heat emitted spontaneously during the decomposition of the solid hydrogen-generating material into a gas to the whole hydrogen-generating material.

In an exemplary embodiment, the hydrogen-generating container is one receiving a hydrogen-generating material capable of heat emission and dehydrogenation under heating. The hydrogen-generating container includes a hydrogen discharge path, through which the generated hydrogen is discharged, on the wall surface thereof.

In another exemplary embodiment, the container may be a cylindrical casing, which includes a through-hole for hydrogen discharge on one circular wall surface thereof and a line-shaped hydrogen discharge path on a lateral surface thereof. The hydrogen discharge path may have a controlled size and pattern so that any materials entrained during the generation of hydrogen may be present in the container.

In the exemplary embodiments disclosed herein, there is no particular limitation in the material for forming the hydrogen-generating container. However, the cost, heat conductivity, rigidity, etc. of the material should be taken into consideration. The hydrogen-generating container may be formed of a material having low heat conductivity in order to prevent each hydrogen-generating container from initiating exothermic reaction without heat supply from a heating unit due to the heat generated between the adjacent hydrogen-generating containers, when a plurality of hydrogen-generating containers are arranged in a hydrogen supply tank. Non-limiting examples of the material for forming the hydrogen-generating container may include engineering plastics, SUS alloy, duralumin, etc. More particularly, the hydrogen-generating container may be formed of duralumin. Further, non-limiting examples of engineering plastics may include acrylonitrile butadiene styrene (ABS), polycarbonate (PC), polyamide (PA), polybutylene terephthalate (PBT), etc. Non-limiting examples of SUS alloy may include SUS 304, SUS 316 alloy, etc.

The hydrogen-generating container is mounted to the hydrogen supply tank, and hydrogen discharged from the container is stored in the hydrogen supply tank before supplied to an external hydrogen consuming device.

In the exemplary embodiments disclosed herein, the hydrogen supply tank includes at least one hydrogen-generating container mounted thereto, and stores hydrogen discharged from the hydrogen-generating container and supplies the hydrogen to external sites, wherein the tank has a plurality of divided sections, and the hydrogen-generating container is mounted to each divided section. The tank may be provided with a path through which the hydrogen is supplied to external sites.

Such a design of divided sections serves to facilitate installment of a plurality of hydrogen-generating containers in the hydrogen supply tank. In other words, the inner space of the hydrogen supply tank is divided preliminarily in a suitable manner and the hydrogen-generating containers are disposed while being spaced apart from each other by a predetermined distance. In this manner, the number of hydrogen-generating containers mounted to the tank may be maximized. In addition, since the containers are spaced apart from each other, it is possible to prevent heat emission during the hydrogen generation in one hydrogen-generating container from causing hydrogen generation in another container without heat supply from a heating unit. As a result, it is possible to increase hydrogen generation efficiency.

As mentioned above, the design of tank having divided sections allows the hydrogen-generating containers to be arranged adequately in the tank. In addition to this, such a design results in an increase in pressure against which the tank resists (i.e., improvement in pressure resistance), thereby realizing an improved hydrogen storage capacity based on the same weight of tank. For reference, although a box-shaped tank is hardly used for high pressure applications in general, the design of tank having divided sections, particularly formed in a lattice type, enables a box-shaped tank to resist against high pressure.

In an exemplary embodiment, the divided sections of the tank may be formed by a separator disposed in the tank. The separator may be linked to the tank housing. In this case, it is possible to further increase the pressure against which the tank resists.

Due to the above-described tank structure, it is possible to overcome the limitation in pressure resistance of a low-weight material, even when the tank is formed of a low-weight material.

In an exemplary embodiment, the divided sections of the tank have the form of a lattice and a single hydrogen-generating container may be mounted to each divided section. At least one of the divided sections may have no hydrogen-generating container in order to discharge hydrogen from the tank to the exterior.

In an exemplary embodiment, the hydrogen-generating container is mounted to each divided section of the hydrogen supply tank, and the hydrogen-generating container may be attached/detached to/from each section. After generating all hydrogen from the hydrogen-generating material in an individual hydrogen-generating container, the hydrogen-generating container may be detached from the hydrogen supply tank, and then a new hydrogen-generating material may be filled into the corresponding hydrogen-generating container or the used hydrogen-generating material may be filled back into the container after regeneration. Then, the hydrogen-generating container may be attached back to the hydrogen supply tank. Such a detachable structure permits freedom of installment of hydrogen-generating containers.

In an exemplary embodiment, the hydrogen supply tank may include 25 (5×5) lattice-type divided sections, and the central section has no hydrogen-generating container so that it serves as a hydrogen discharge path toward the exterior.

The numbers of divided sections and hydrogen-generating containers are in proportion to the hydrogen capacity to be stored. For reference, when the hydrogen supply tank has a volume of 1.5-2 L, 9-49, particularly 25 hydrogen-generating containers each having a volume of 30 cc may be provided.

The distance between one hydrogen-generating container and another mounted to the adjacent divided sections may be greater than 0.5 cm and equal to or less than 2 cm. If any two adjacent hydrogen-generating containers are spaced from each other insufficiently (i.e., distance ≦0.5 cm), a chain reaction may occur. When the distance exceeds 2 cm, the hydrogen supply tank becomes too big.

In an exemplary embodiment, the hydrogen supply tank may have a volume of 2 L to 70 L depending on its particular application. Hydrogen supply tanks having different volumes may be used for different applications. For example, a hydrogen supply tank applied to a vehicle may have a volume of 70 L.

In another exemplary embodiment, hydrogen may be stored in the hydrogen supply tank under a low pressure of 20 atm or less.

Two or more tanks may be connected in series to increase hydrogen storage and supply efficiency.

In an exemplary embodiment, two or more tanks may be connected in series while being spaced apart from each other by a predetermined distance.

In another exemplary embodiment, two or more tanks connected in series may be connected to a hydrogen conveying tube interposed between the two tanks.

The hydrogen supply tank may be formed of a low-weight material. Non-limiting examples of the material may include any one selected from engineering plastics, SUS alloy and duralumin. Particularly, the low-weight material may be duralumin.

In the exemplary embodiments disclosed herein, a minimized level of heat (or electric power) is applied to the hydrogen supply tank to cause hydrogen generation, and then the reaction heat from the hydrogen generation allows spontaneous dehydrogenation. Therefore, when the tank pressure is measured and the pressure reaches a predetermined level, energy (or electric power) supply may be controlled.

The hydrogen generating apparatus disclosed herein may include: a hydrogen supply tank having a hydrogen-generating container mounted thereto; an electric power source that supplies electric power to a heating unit supplying heat to a hydrogen-generating material in the hydrogen-generating container mounted to the hydrogen supply tank, thereby performing heat emission; and a controller that controls electric power supply from the electric power source.

Herein, the controller may be mounted to outside of the hydrogen supply tank. Mounting the controller inside of the hydrogen supply tank may cause spark generation. For example, the controller may be a semiconductor chip-type controller. Such controllers are known to those skilled in the art, and may be attached to a hydrogen consuming device, such as a vehicle.

In an exemplary embodiment, the controller may be connected to a circuit board, and the circuit board may include electric wires connected to the heating unit capable of inducing heat generation from the hydrogen-generating material. The circuit board may be installed outside of each hydrogen supply tank. By mounting a circuit board to each hydrogen supply tank, it is possible to prevent formation of complicated wirings and an increase in weight of the hydrogen supply tank, thereby providing the hydrogen supply tank with low weight.

In an exemplary embodiment, the hydrogen supply tank may be provided as a hydrogen supply tank package having a plurality of tanks connected in series, and a single controller may be used per package. This enables minimization of the number of controllers, thereby providing the overall system with low weight.

In an exemplary embodiment, the hydrogen supply tank may be provided as a hydrogen supply tank package having a plurality of tanks connected in series, a single controller, which may be used per package, may be connected to the circuit board mounted to outside of each hydrogen supply tank.

The hydrogen supply tank may be connected to a pressure measuring unit, such as a pressure gauge or pressure sensor, measuring the pressure inside of the tank. For example, a pressure gauge or pressure sensor may be mounted directly to the hydrogen supply tank.

The hydrogen supply tank may be connected to a safety valve. When the pressure in the hydrogen supply tank exceeds a predetermined level, the safety valve is opened to discharge hydrogen from the hydrogen supply tank.

The hydrogen supply tank may be connected to at least one selected from a filter unit filtering solid materials present in the gas discharged from the hydrogen supply tank, and a trap unit capturing gaseous byproducts produced from the hydrogen generation reaction and present in the gas discharged from the hydrogen supply tank. For example, the gas discharged from the hydrogen supply tank is passed through the filter unit and the trap unit, and then the filter unit again.

A regulator may be further provided to regulate hydrogen discharge before the hydrogen supplied from the hydrogen supply tank is sent to a hydrogen consuming device.

The hydrogen supply apparatus including the hydrogen supply tank may be constructed as follows.

In other words, the hydrogen supply apparatus may include: a pressure measuring unit connected to the hydrogen supply tank; a valve connected to the hydrogen supply tank; a filter unit filtering solid materials present in the hydrogen-containing material discharged through the valve; and a trap unit capturing gaseous byproducts produced from the hydrogen generation reaction and present in the hydrogen-containing material discharged from the hydrogen supply tank. In the trap unit, a solvent, such as water, capable of dissolving polar substances may be used. The hydrogen supply apparatus may further include a regulator regulating hydrogen discharge before the hydrogen is discharged to the hydrogen consuming device.

The hydrogen consuming device disclosed herein may use hydrogen supplied from at least one hydrogen supply tank or hydrogen supply apparatus, and may perform hydrogen combustion or electric power generation. Alternatively, the hydrogen consuming device may be one driven by electric power supplied from such an electric power generation device.

The hydrogen consuming device may be a fuel cell, such as a polymer electrolyte fuel cell. The hydrogen consuming device may also be a vehicle to which electric power is supplied from the fuel cell.

The hydrogen supply tank or the hydrogen supply apparatus disclosed herein may be maintained at low pressure and low weight, and allow easy control of exothermic reaction and low-pressure operation. Thus, the hydrogen supply tank or the hydrogen supply apparatus may be useful, particularly when mounted to a fuel cell vehicle.

Some embodiments of the present disclosure will be explained in more detail with reference to the accompanying drawings.

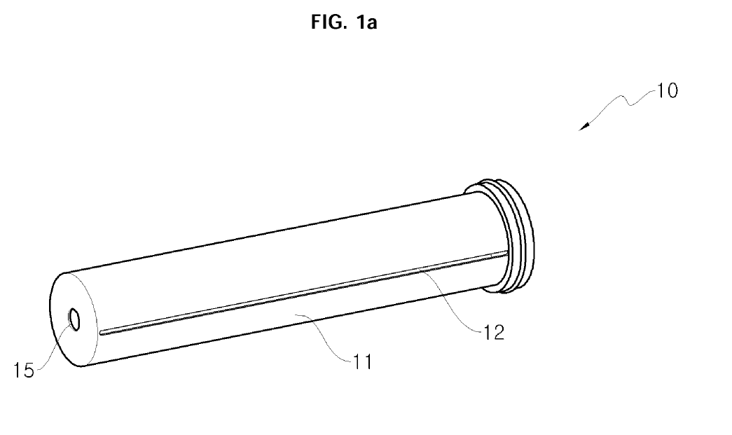

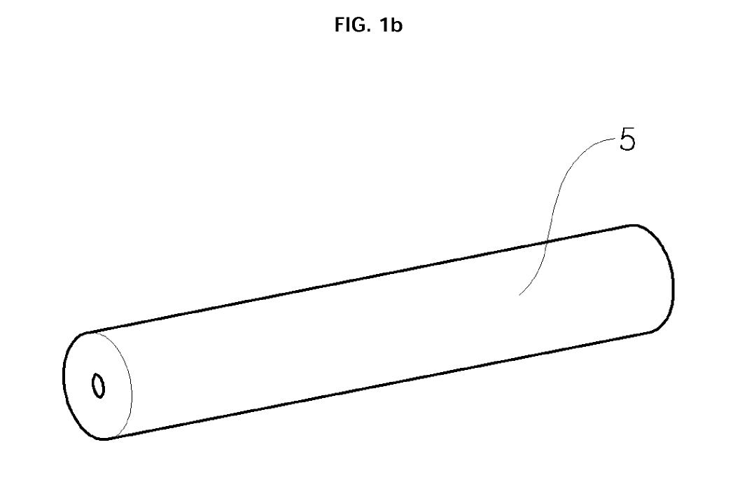

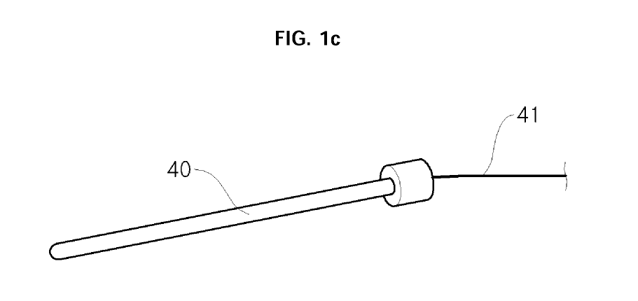

FIG. 1 is a schematic view illustrating a hydrogen-generating container according to an exemplary embodiment.

Referring to FIG. 1a, a hydrogen-generating container 10 receives a hydrogen-generating material 5 (see FIG. 1b). The container 10 includes a cylindrical main body 11, a line-shaped hydrogen discharge path 12 formed on a lateral surface of the main body 11, and a through-hole 15 formed on one circular surface of the main body for hydrogen discharge.

The hydrogen-generating container 10 is opened at the side opposite to the side having the through-hole 15, and the open portion permits reception or discharge of the hydrogen-generating material 5 (see, FIG. 1b). Although the hydrogen-generating container is shown in the form of a cylinder in FIG. 1a, the hydrogen-generating container is not limited thereto and may be designed to have various shapes depending on the type of the hydrogen-generating material and the shape of the hydrogen supply tank.

A heating unit, such as a heating rod 40 that emits heat after receiving electric power from an external electric power source, may be incorporated to the hydrogen-generating container 10 through the open portion. The heating rod 40 may be further provided with an electric wire 41 to be connected to an electric power source (see, FIG. 1c).

The hydrogen-generating material 5 received in the hydrogen-generating container 10 may be provided as solid pellets having an opening (see, FIG. 1b).

As mentioned above, the heating rod (see, FIG. 1c) may be present in the hydrogen-generating container along the opening of the pellet-like hydrogen-generating material.

The hydrogen-generating container 10 may have different volumes depending on the volume of the hydrogen supply tank as described hereinafter. However, the hydrogen-generating container 10 may have a volume of 7 cc-20 cc to provide a low-weight compact hydrogen supply system and to realize a low-pressure hydrogen supply tank with a pressure of 20 atm or less, as described hereinafter.

As mentioned earlier, the hydrogen-generating container may be formed of a low-weight material, and non-limiting examples thereof may include engineering plastics, SUS alloy or duralumin. Particularly, duralumin may be used since it is rigid and light.

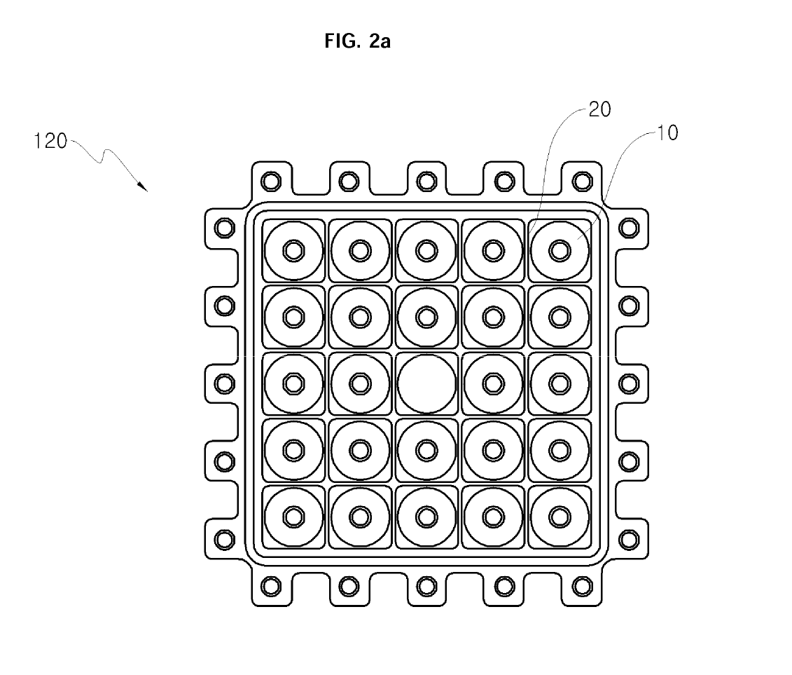

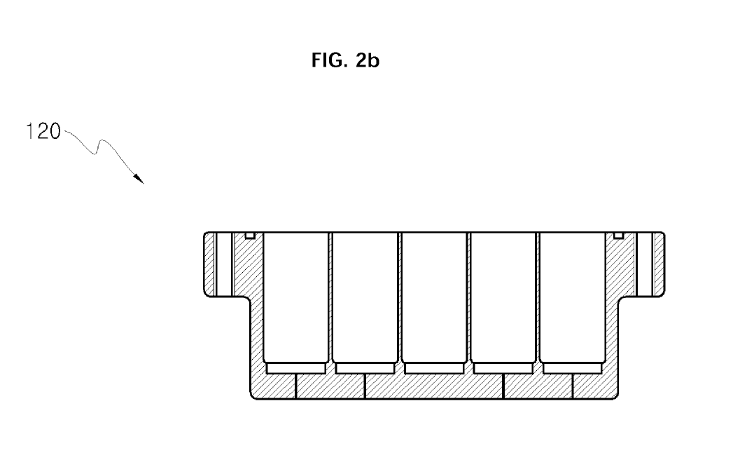

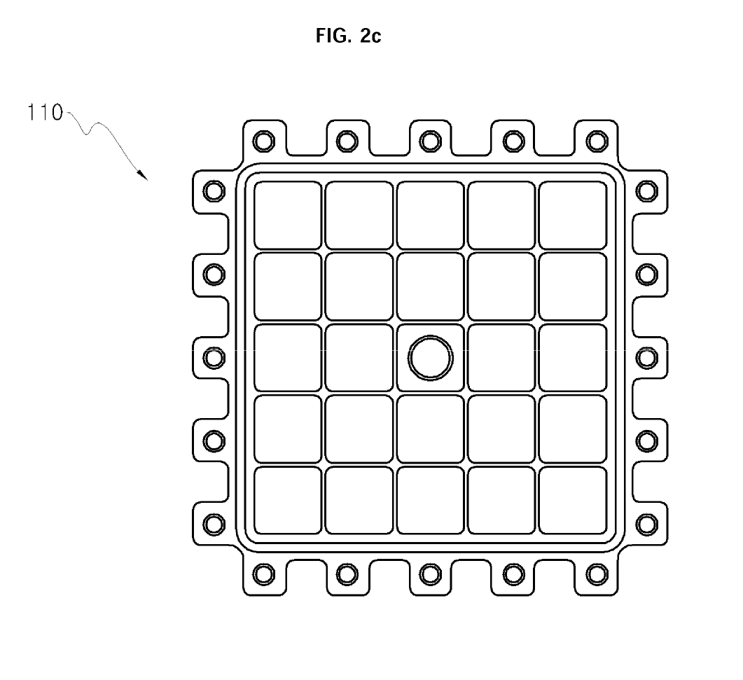

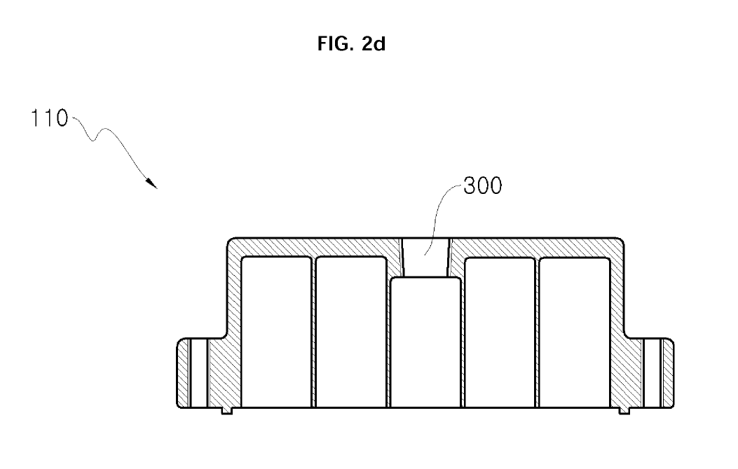

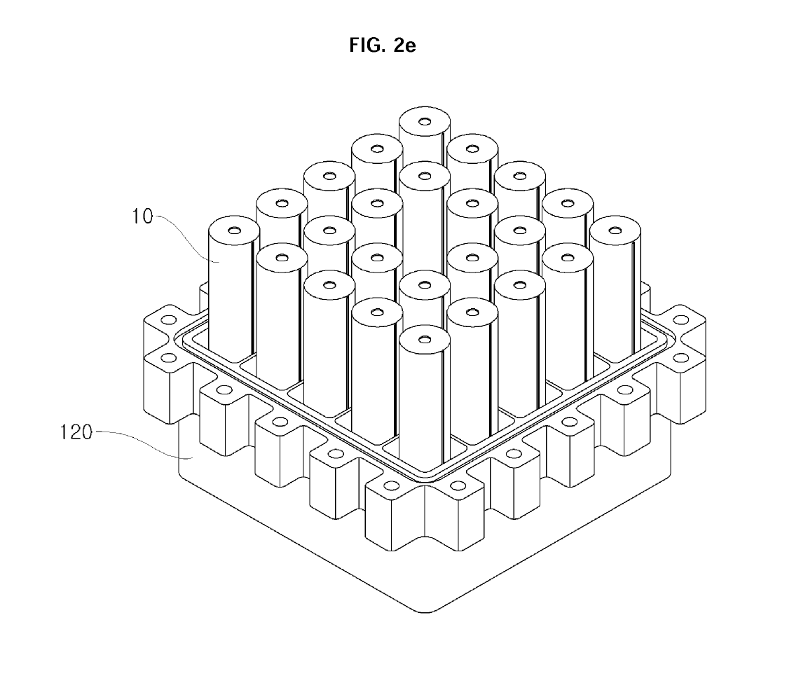

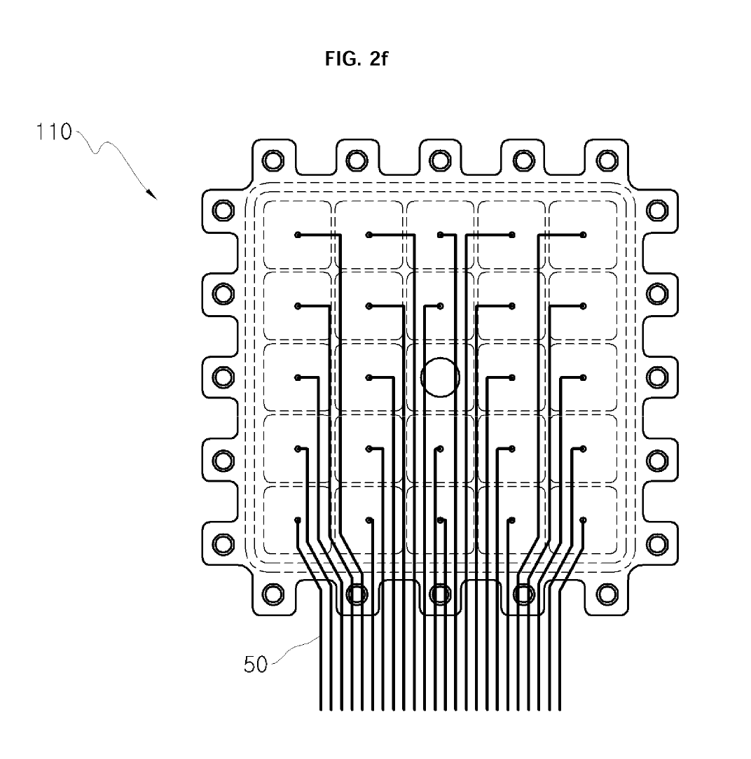

FIG. 2 is a schematic view illustrating a hydrogen supply tank according to an exemplary embodiment. Particularly, FIG. 2a is a schematic view illustrating the structure of the lower housing of a hydrogen supply tank according to an exemplary embodiment; FIG. 2b is a schematic sectional view illustrating the structure of the lower housing of the hydrogen supply tank as shown in FIG. 2a; FIG. 2c is a schematic view illustrating the structure of the upper housing of a hydrogen supply tank according to an exemplary embodiment; and FIG. 2d is a schematic sectional view illustrating the structure of the upper housing of the hydrogen supply tank as shown in FIG. 2c.

Referring to FIG. 2a and FIG. 2b, the lower housing 120 of the hydrogen supply tank has divided sections to which the hydrogen-generating container 10 is mounted. The divided sections may be formed by a separator 20. The separator 20 may be mounted to the lower housing 120 of the tank, and may be formed integrally with the lower housing.

FIG. 2a shows 25 divided sections, including 5 divided sections per row and 5 divided sections per column. Among the divided sections, the central divided section has no hydrogen-generating container, and may serve as a discharge path for the generated hydrogen.

Referring to FIG. 2c and FIG. 2d, the upper housing 110 of the hydrogen supply tank have divided sections that may correspond to those of the lower housing 120. The hydrogen-generating containers 10 are disposed in the space formed by the corresponding divided sections. The divided sections of the upper housing may also be formed by a separator 20, which may be mounted to the upper housing 110, particularly may be formed integrally with the upper housing.

Like FIG. 2a, FIG. 2c shows 25 divided sections, including 5 divided sections per row and 5 divided sections per column. Among the divided sections, the central divided section has no hydrogen-generating container, and may serve as a discharge path for the generated hydrogen.

As shown in FIG. 2e, when the hydrogen-generating container 10 is mounted, an electric wire 41 (see, FIG. 1c) connected to the heating rod 40 incorporated to the hydrogen-generating container may be drawn out of the lower housing 120 of the hydrogen supply tank and may be connected to an external controller.

FIG. 2e is a schematic view illustrating 24 hydrogen-generating containers mounted to the lower housing of the hydrogen supply tank according to an exemplary embodiment.

Meanwhile, when the electric wire 41 of each heating rod is drawn out of each hydrogen-generating container and is further drawn out of the hydrogen supply tank so as to be connected to an external electric power source, such a large number of electric wires occupies an excessively large space and causes difficulty in arranging the wires. Therefore, to overcome such problems, a circuit board may be installed outside of the hydrogen supply tank. The circuit board includes an assembly of electric wires connecting the heating rods individually to an electric power source.

FIG. 2f is a schematic view illustrating a circuit supplying electric power to the heating rod of each hydrogen-generating container according to an exemplary embodiment.

As shown in FIG. 2f, the circuit 50 includes electric wires to be connected individually to the heating rod of each hydrogen-generating container. The circuit 50 is formed on a board to provide a circuit board. Methods for forming a circuit on a board are well known per se.

The circuit board may be connected to a controller, and electric power may be distributed throughout each circuit according to the signals of the controller. In this manner, electric power may be distributed and supplied to the heating rod of each hydrogen supply container.

For reference, the hydrogen-generating containers should be spaced apart from each other by a predetermined distance, in such a manner that a temperature increase (e.g. about 150° C.) caused by the heat emission during hydrogen generation dose not arise further hydrogen generation in the adjacent solid hydrogen-generating material.

The distance between two adjacent hydrogen-generating containers affects the design of divided sections. Although there is no particular limitation in the distance, the distance may be greater than 0.5 cm and equal to or less than 2 cm. When the distance is 0.5 cm or less, a chain reaction may occur in the adjacent hydrogen-generating container in the absence of heat supply from a heating unit. On the other hand, when the distance exceeds 2 cm, the tank size may increase undesirably.

The hydrogen supply tank 100 may have a volume of 2 L-70 L depending on its particular use, and the above range may provide the tank with low weight and a compact size. In addition, the hydrogen supply tank 100 may be constructed to have an internal pressure of 20 atm or less.

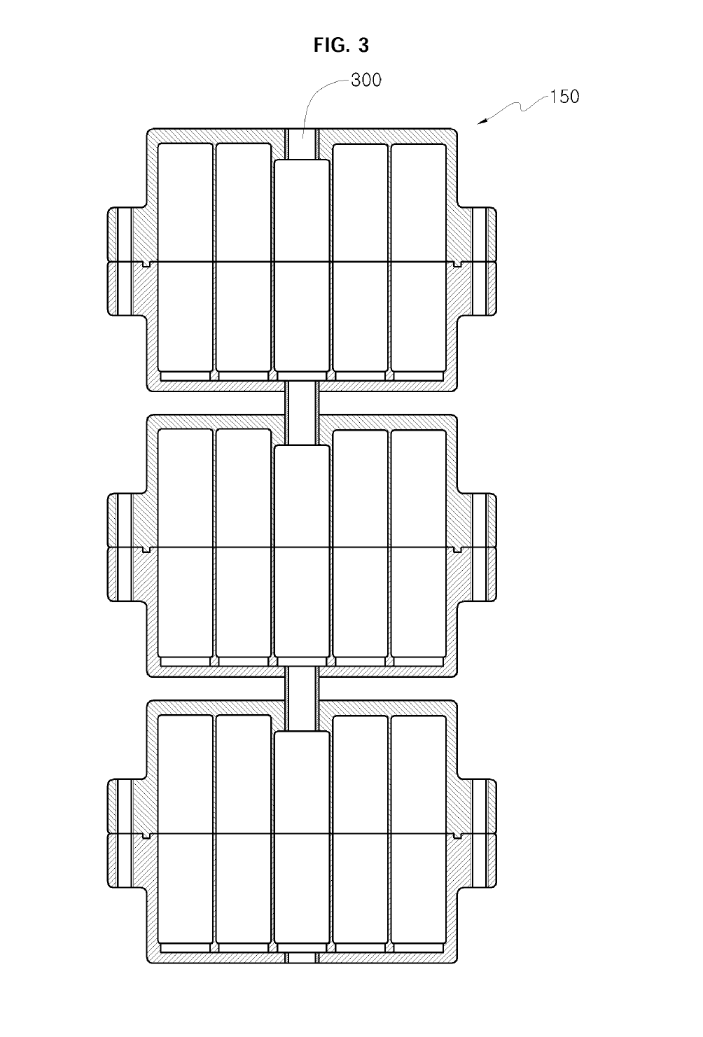

FIG. 3 is a schematic view illustrating a plurality of hydrogen supply tanks arranged in series to form a package according to an exemplary embodiment. Although FIG. 3 shows a package having 3 tanks, the present disclosure is not limited thereto.

As shown in FIG. 3, a plurality of hydrogen supply tanks 150 according to the exemplary embodiments disclosed herein are connected in series. A hydrogen conveying tube 300 may be formed between one tank and another tank. As mentioned above, a plurality of hydrogen supply tanks connected in series is effective for controlling the pressure and for constructing a hydrogen supply apparatus having an adequate scale.

When connecting the hydrogen supply tanks 150 in the above-described manner, each hydrogen supply tank 150 may be provided with a circuit board to solve the problem of intricate wirings.

In addition, when a plurality of tanks are connected in series to form a hydrogen supply tank package, a single controller may be used per package, thereby minimizing the number of required controllers and providing the overall system with low weight.

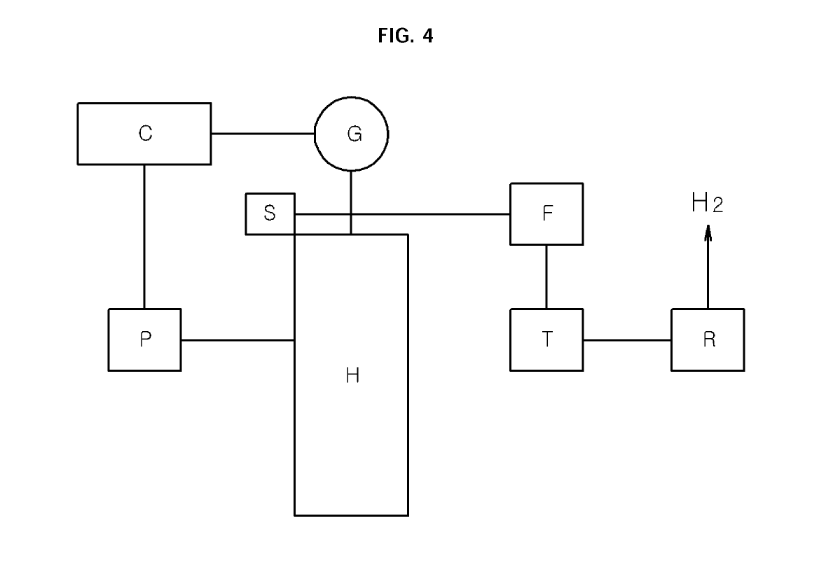

FIG. 4 is a schematic view illustrating a hydrogen supply apparatus including a hydrogen supply tank according to the exemplary embodiments disclosed herein.

Referring to FIG. 4, the hydrogen supply tank H is connected to a pressure measuring unit G to measure the pressure of the hydrogen supply tank. The hydrogen supply tank has a safety valve S mounted thereto. The pressure measuring unit G is connected to a controller C, which controls electric power supply from an electric power source P linked to the heating unit of the hydrogen supply tank based on the pressure measurement.

The hydrogen-containing material generated from the hydrogen supply tank is passed through a filter unit F to filter off solid materials present in the hydrogen-containing material. Gaseous byproducts generated during the hydrogen generation and present in the hydrogen-containing material passed through the filter unit F is captured by being passed through a trap unit T. In the trap unit T, a solvent (e.g. water) capable of dissolving polar substances may be used. The hydrogen passed through the trap unit T is further passed through a regulator R and then discharged to a hydrogen consuming device.

In the hydrogen supply method according to the exemplary embodiments disclosed herein, a hydrogen-generating material capable of heat emission and dehydrogenation under heating is used to accomplish storage and supply of hydrogen with high efficiency in diversified low-pressure, low-weight, pressure resistant modes. In addition, the hydrogen supply method facilitates control of exothermic reaction and low-pressure operation.

The hydrogen supply apparatus and method are useful for fuel cell vehicles.

### EXAMPLES

The examples (and experiments) will now be described. The following examples (and experiments) are for illustrative purposes only and not intended to limit the scope of the present disclosure.

### Example 1

A hydrogen-generating container is constructed as shown in FIG. 1.

Twenty four hydrogen-generating containers are mounted to a hydrogen supply tank having 25 divided sections as shown in FIG. 2. One hydrogen-generating container is spaced apart from the adjacent container by 1 cm. The hydrogen supply tank has a transverse length of 18 cm and a longitudinal length of 18 cm as a whole.

Each hydrogen-generating container has a volume of 9 cc and is formed of duralumin. The hydrogen supply tank has a volume of 1.7 L and is formed of duralumin.

A circuit board is mounted into the hydrogen supply tank and 24 heating rods are mounted to the circuit board (see, FIG. 2e). Each heating rod uses a 125 ohm resistance line and a 70 V electric power source is used to apply electric power to the circuit board.

To perform a test in this Example, 4.62 g of ammonia borane is filled into each hydrogen-generating container on average.

To control electric power supply, electric power is supplied to the heating rod only for 1.5 minutes when using a 70 V electric power source is used for a 125 ohm resistance line. Under the above condition, all producible hydrogen is generated. There is no chain reaction caused by the reaction heat of the adjacent hydrogen-generating container. In the hydrogen-generating container mounted to the tank, 4.2 L of hydrogen is generated on average. The whole tank is maintained at a pressure of 2 atm or less. This results from the generation of 8.12 wt % of hydrogen from ammonia borane.

Table 1 shows the amount of ammonia borane (AB) and hydrogen generation amount for 4 hydrogen-generating containers optionally selected from the 24 hydrogen-generating containers.

TABLE 1

| | | | Hydrogen | |
|---|---|---|---|---|
| | | | generation | |
| | AB (g) | AB (gmol) | amount (L) | H₂/AB (wt %) |
| 1 | 5.07 | 0.165 | 3.842 | 6.766 |
| 2 | 5.24 | 0.170 | 5.498 | 9.368 |
| 3 | 4.14 | 0.134 | 3.990 | 8.605 |
| 4 | 4.02 | 0.130 | 3.478 | 7.725 |
| Average | 4.618 | 0.150 | 4.202 | 8.116 |

According to the exemplary embodiments, it is possible to realize generation, storage and supply of hydrogen with high efficiency, and to maintain a hydrogen supply tank in a low-pressure and low-weight mode. In addition, it is easy to control the exothermic reaction and operation during the generation of hydrogen from the hydrogen-generating material.

Further, the design of the inner part of a tank having divided sections as mentioned above improves pressure resistance of the tank made of a low-weight material, which, otherwise may be degraded. In addition to the above, the circuit board installed outside of each hydrogen supply tank solves the problem of an increase in weight caused by wirings. Moreover, use of a single controller that controls a package of hydrogen supply tanks arranged in series minimizes requirement of controller installment.

While the exemplary embodiments have been shown and described, it will be understood by those skilled in the art that various changes in form and details may be made thereto without departing from the spirit and scope of the present disclosure as defined by the appended claims.

In addition, many modifications can be made to adapt a particular situation or material to the teachings of the present disclosure without departing from the essential scope thereof. Therefore, it is intended that the present disclosure not be limited to the particular exemplary embodiments disclosed as the best mode contemplated for carrying out the present disclosure, but that the present disclosure will include all embodiments falling within the scope of the appended claims.

What is claimed is:

1. A hydrogen supply tank comprising at least one hydrogen-generating container mounted thereto, wherein the hydrogen-generating container receives a hydrogen-generating material capable of heat emission and dehydrogenation under heating, and has a hydrogen discharge path that allows discharge of the generated hydrogen, on the wall surface thereof; the tank has a plurality of divided sections formed therein; the hydrogen-generating container is mounted to each section; and the hydrogen supply tank stores the hydrogen discharged from the hydrogen-generating container and supplies the hydrogen to external sites.

2. The hydrogen supply tank according to claim 1, wherein the divided sections of the tank are formed by a separator installed in the tank.

3. The hydrogen supply tank according to claim 1, wherein the divided sections of the tank are lattice-like divided sections, and at least one divided section has no hydrogen-generating container in order to discharge hydrogen from the tank to external sites.

4. The hydrogen supply tank according to claim 1, which comprises a plurality of tanks connected to each other in series.

5. The hydrogen supply tank according to claim 4, wherein a hydrogen conveying tube is interposed between the tanks connected in series.

6. The hydrogen supply tank according to claim 1, which further includes a circuit board mounted to outside thereof, wherein the circuit board includes electric wires connected to a heating unit supplying heat to the hydrogen-generating material.

7. The hydrogen supply tank according to claim 1, wherein the tank has a box-like shape having lattice-like divided sections.

8. The hydrogen supply tank according to claim 1, wherein the hydrogen-generating container is a cylindrical casing in which a hydrogen-generating material capable of heat emission and dehydrogenation under heating is received, and the cylindrical casing has a through-hole formed on one circular wall surface thereof so as to allow hydrogen discharge and a line-shaped hydrogen discharge path formed on a lateral surface thereof.

9. The hydrogen supply tank according to claim 1, wherein the hydrogen-generating material is provided as a pellet having an opening.

10. The hydrogen supply tank according to claim 1, wherein the hydrogen-generating container further comprises a heating unit supplying heat to the hydrogen-generating material.

11. The hydrogen supply tank according to claim 10, wherein the heating unit generates heat under the supply of electric power from an electric power source.

12. The hydrogen supply tank according to claim 10, wherein the heating unit is detachable from the hydrogen-generating container.

13. The hydrogen supply tank according to claim 1, wherein the hydrogen-generating container has a volume of 7 cc-20 cc.

14. The hydrogen supply tank according to claim 1, wherein the hydrogen-generating container is formed of any one material selected from engineering plastics, SUS alloy and duralumin.

15. The hydrogen supply tank according to claim 1, wherein the hydrogen-generating material is an amine borane-based material.

16. The hydrogen supply tank according to claim 1, wherein the hydrogen-generating material is ammonia borane.

17. The hydrogen supply tank according to claim 1, wherein the hydrogen-generating container is mounted to the hydrogen supply tank in such a manner that it is attached/detached to/from the hydrogen supply tank.

18. The hydrogen supply tank according to claim 1, wherein the hydrogen-generating containers are spaced apart from each other by a predetermined distance to prevent heat emission during the hydrogen generation in one hydrogen-generating container from causing hydrogen generation in another hydrogen-generating container even in the absence of heat supply from a heating unit.

19. The hydrogen supply tank according to claim 18, wherein the hydrogen-generating containers are spaced apart from each other by a distance greater than 0.5 cm and equal to or less than 2 cm.

20. The hydrogen supply tank according to claim 1, which has a volume of between 2 L and 70 L.

21. The hydrogen supply tank according to claim 1, which stores hydrogen under a pressure of 20 atm or less.

22. The hydrogen supply tank according to claim 1, which is formed of any one material selected from engineering plastics, SUS alloy and duralumin.

23. The hydrogen supply tank according to claim 1, which is connected to a pressure measuring unit.

24. The hydrogen supply tank according to claim 1, which is connected to a safety valve.

25. The hydrogen supply tank according to claim 1, which is connected to at least one unit selected from a filter unit filtering solid materials present in the gas discharged from the hydrogen supply tank, and a trap unit capturing gaseous byproducts produced from the hydrogen generation reaction and present in the gas discharged from the hydrogen supply tank.

26. A hydrogen supply apparatus, comprising:
the hydrogen supply tank as defined in claim 1;
an electric power source that supplies electric power to the heating unit supplying heat to the hydrogen-generating material in the hydrogen-generating container mounted to the hydrogen supply tank, thereby emitting heat; and
a controller that controls supply of electric power from the electric power source.

27. The hydrogen supply apparatus according to claim 26, wherein the hydrogen supply tank comprises a plurality of tanks connected to each other in series to form a hydrogen supply tank package, and a single controller is provided per package.

28. The hydrogen supply apparatus according to claim 26, wherein the controller is connected to a circuit board installed outside the hydrogen supply tank, and the circuit board comprises electric wires connected to the heating unit.

29. The hydrogen supply apparatus according to claim 26, which further comprises a pressure measuring unit connected to the hydrogen supply tank, wherein when the pressure measured by the pressure measuring unit reaches a predetermined level, electric power supply from the electric power source is interrupted.

30. The hydrogen supply apparatus according to claim 26, which comprises:
a valve connected to the hydrogen supply tank;
a filter unit filtering solid materials present in the hydrogen-containing material discharged through the valve;
a trap unit capturing gaseous byproducts generated from hydrogen generation and present in the hydrogen-containing material discharged through the filter unit; and
a regulator that regulates discharge of hydrogen passed through the trap unit.

31. A hydrogen-consuming device comprising the hydrogen supply tank as defined in claim 1.

32. The hydrogen-consuming device according to claim 31, which comprises a fuel cell to which hydrogen is supplied from the hydrogen supply tank.

33. The hydrogen-consuming device according to claim 31, which is a vehicle driven partially or totally by power transmitted from the fuel cell.

34. A hydrogen-consuming device comprising the hydrogen supply apparatus as defined in claim 26.

35. The hydrogen-consuming device according to claim 34, which comprises a fuel cell to which hydrogen is supplied from the hydrogen supply tank.

36. The hydrogen-consuming device according to claim 34, which is a vehicle driven partially or totally by power transmitted from the fuel cell.

37. A hydrogen supply method, comprising:
applying heat to a hydrogen-generating material capable of heat emission and dehydrogenation under heating in a hydrogen-generating container to generate hydrogen, wherein the hydrogen-generating container receives the hydrogen-generating material, and has a hydrogen discharge path that allows discharge of the generated hydrogen, on the wall surface thereof;
discharging the generated hydrogen from the hydrogen-generating container; and
storing the discharged hydrogen, in a tank divided section-wise to mount the hydrogen-generating container and supplying the hydrogen to a hydrogen-consuming device.

38. The hydrogen supply method according to claim 37, wherein the hydrogen-generating material is heated initially, heating is terminated once hydrogen generation is initiated, and hydrogen is further generated by reaction heat of the hydrogen-generating material.

39. The hydrogen supply method according to claim 37, wherein the hydrogen stored in the tank is measured for pressure and the heating of the hydrogen-generating material is terminated when the pressure reaches a predetermined level.

40. The hydrogen supply method according to claim 37, wherein hydrogen is discharged by opening a tank valve when the pressure of hydrogen stored in the tank reaches a predetermined value.

41. The hydrogen supply method according to claim 37, wherein the pressure inside the tank is maintained at 20 atm or less.
